(19) United States
(12) Patent Application Publication
(10) Pub. No.: US 2013/0105708 A1
(43) Pub. Date: May 2, 2013

(54) Narrow band fluorophore exciter

(71) Applicants: Gordon Bennett, Albuquerque, NM (US); John J. Cousins, Albuquerque, NM (US)

(72) Inventors: Gordon Bennett, Albuquerque, NM (US); John J. Cousins, Albuquerque, NM (US)

(21) Appl. No.: 13/373,032

(22) Filed: Nov. 2, 2011

(51) Int. Cl. G01N 21/64; H05B 37/02

(52) U.S. Cl. 250/459.1; 315/151; 250/458.1

(57) ABSTRACT

Disclosed is a solid-state light source based on a light emitting diode (LED) array driven by a constant current power source with an active feedback control. This system can be implemented for broad frequency ranges or for narrow band frequencies depending on the characteristics of the LEDs chosen to populate the array and the geometry of the array. The invention can be used as an excitation light source for fluorescent microscopy and flow cytometry applications as an efficient and stable alternative to existing light sources such as broadband mercury vapor bulbs and plasma-based light sources. Benefits of the current invention include: durability; stability; reduced operating expenses; reduced variance of output; and increased accuracy of frequency and amplitude. This system will provide benefits as the excitation mechanism in fluorescent identification and measurement systems such as microscopy and flow cytometry.

### BACKGROUND OF THE INVENTION

1. Field of the Invention

The present invention is a system and methods for a solid-state light source based on a light emitting diode (LED) array driven by a constant current power source with an active feedback control. This system can be implemented for broad frequency ranges or for narrow band frequencies depending on the characteristics of the LEDs chosen to populate the array and the geometry of the array.

2. Description of the Prior Art

U.S. Pat. No. 7,564,622 describes a method for making A microscope that enables a phase object or surface pits and projections to be observed at a relatively low image-formation magnification of 4 or lower over a wide viewing range yet in a relatively narrow spatial frequency distribution range. The microscope comprises a light source, an illumination optical system, a partial aperture located at the pupil position of the illumination optical system, an image-formation optical system, and an eyepiece optical system or an image pickup optical system, wherein the diameter of the image of a partial aperture at the pupil position of the image-formation optical system is set smaller than the pupil diameter of the image-formation optical system, and at the pupil position of the image-formation optical system there is located an element for introducing in the pupil position of the image-formation optical system a wavefront varying in size with the pupil diameter.

This patent describes a method for implementing microscopy and microscopic measurement as well as microscope and apparatus for implementing them. The light source description in the patent details creating a uniform wave-front for image formation. For creating a uniform wave-front for image formation, the light source must be a coherent light source. It does not teach or describe a method or system for a bandwidth tailored solid state light source of high stability.

U.S. Pat. No. 7,317,194 describes a method for an optical imager, such as a microscope for performing multiple frequency fluorometric measurements comprising a light source, such as a laser source is disclosed. The system is used to excite a sample into the fluorescent state. Light from the excited sample is collected by a microscope. The microscope utilizes conventional confocal optics optimized to have a very narrow depth of field, thus limiting the information collected to a thin planar region. Measurements are taken over the fluorescence lifetime of the sample simultaneously from the excitation source and from the excited sample. Information is taken in a matrix and comparison of the image matrix and the standard during simultaneous measurements yields output information.

This patent describes a method for implementing a microscope for performing multiple frequency fluorometric measurements. The light source description in this patent details a laser light source. It is a confocal optic implementation for very narrow depth of focus which requires a coherent light source (laser). The current invention is not concerned with a narrow depth of focus application. It does not teach or describe a method or system for a bandwidth tailored solid state Light Emitting Diode array light source of high stability.

U.S. Pat. No. 7,297,962 describes a method for an optical imager, such as a microscope for performing multiple frequency fluorometric measurements comprising a light source, such as a laser source is disclosed. The system is used to excite a sample into the fluorescent state. Light from the excited sample is collected by a microscope. The microscope utilizes conventional confocal optics optimized to have a very narrow depth of field, thus limiting the information collected to a thin planar region. Measurements are taken over the fluorescence lifetime of the sample simultaneously from the excitation source and from the excited sample. Information is taken in a matrix and comparison of the image matrix and the standard during simultaneous measurements yields output information.

This patent describes a method for implementing a method for performing spatially coordinated high speed fluorometric measurements with a laser source. The light source description in this patent details a laser light source. It is a confocal optic implementation for very narrow depth of focus which requires a coherent light source (laser). The current invention is not concerned with a narrow depth of focus application. It does not teach or describe a method or system for a bandwidth tailored solid state Light Emitting Diode array light source of high stability.

U.S. Pat. No. 7,251,038 describes a method for an apparatus for sensing data from a remote optical sensor 16 has its frequency stabilized by balancing the outputs of narrow band filter 28 30, spaced about a desired frequency 36 positioned at about the 3 db down points 40 of a broad band light source 10 using voltage control, current control or temperature control to vary the frequency of the wide band light source 10. Difference between the outputs through the two narrow band filters 28 30 can be used to drive an amplifier 48 to correct the frequency of the broad band light source. The outputs through the two narrow band filters 28 30 can be converted 52 to binary numbers and fed to a microprocessor 56 which is used, via analog conversion 60, to drive the amplifier 48. The broad band light source 10 can be pulse modulated 68 to provide temporally separate light pulses 92 94 through each of the narrow band filters 28 30, measured at separate times. The corrective output to the amplifier 48 can be governed by a ratio between the outputs through the narrow band filters 28 30 rather than by a difference there between.

This patent describes a method for creating narrow band light with a filter system of a broadband light source. It does not teach or describe a method or system for a bandwidth tailored solid state Light Emitting Diode array light source of high stability where the light source itself is actually narrow band and the output of the source is controlled by direct feedback not the control of the frequency. The present invent is a system to control irradiance and not frequency.

U.S. Pat. No. 6,738,397 describes a method for a solid-state light source apparatus includes a first excitation laser light source for outputting a laser beam of a first wavelength, a second excitation laser light source for outputting a laser beam of a second wavelength, a difference frequency between the laser beam of the first wavelength and the laser beam of the second wavelength being in a terahertz band, and a semiconductor pseudo phase matching device which is disposed at a place where a first optical axis of the laser beam of the first wavelength overlaps with a second optical axis of the laser beam of the second wavelength, and generates a terahertz beam in a direction coaxial with the first and second optical axes on the basis of irradiation of the laser beams of the first and second wavelengths. Thus, high output and high efficiency terahertz wave generation can be easily and certainly realized while a narrow line width characteristic is maintained.

The light source description in these patent details a dual laser light source system used to generate a narrow band light source. The dual frequency light source is coaxial and a very different approach from the current invention which implements a single frequency source. It does not teach or describe a method or system for a bandwidth tailored solid state Light Emitting Diode array light source of high stability.

U.S. Pat. No. 6,418,251 describes a method for a laser-diode assembly for generating a frequency-stabilized narrow-bandwidth light comprises a light source in the form of a semiconductor laser diode coupled via a first optical coupling device to one end of a first optical fiber. The other end of this fiber is coupled to a second or an output fiber via a second optical coupling device. The assembly is characterized by the fact that a long inner cavity is formed by a section of the optical system between two oppositely directed mirrors. The first mirror is applied onto the back side of the semiconductor laser diode, and the second mirror is applied onto a flat front side of one optical lens element or onto the back side of another optical lens element. These optical lens elements are parts of an optical coupling between the first and the second fibers. The first mirror completely reflects the entire light incident onto this mirror, whereas the second mirror reflects a major part of the light, e.g., about 90% and passes only a small part, e.g., 10% of the light incident onto this mirror. The Bragg grating is designed so that, in combination with the laser cavity L, it suppresses the side modes of the wavelength bands and transforms them into the central mode of the narrow wavelength band which can be passed through this grating. The light processed by the Bragg grating is passed through the second mirror to the output fiber, while the reflected light performs multiple cycles of reflection between both mirrors which thus form a laser resonator which amplifies the laser light output at the selected narrow waveband.

The light source description in this patent details a laser light diode light source system coupled to an optical fiber and mirror system. This patent teaches an optical filter/amplifier. It does not teach or describe a method or system for a bandwidth tailored solid state Light Emitting Diode array light source of high stability.

### SUMMARY OF THE INVENTION

The present invention is a system and methods for a solid-state light source based on a light emitting diode (LED) array driven by a constant current power source with an active feedback control. This system can be implemented for broad frequency ranges or for narrow band frequencies depending on the characteristics of the LEDs chosen to populate the array and the geometry of the array. The invention can be used as an excitation light source for fluorescent microscopy and flow cytometry applications as an efficient and stable alternative to existing light sources such as broadband mercury vapor bulbs and plasma-based light sources. Benefits of the current invention include: durability; stability; reduced operating expenses; reduced variance of output; and increased accuracy of frequency and amplitude. This system will provide benefits as the excitation mechanism in fluorescent identification and measurement systems such as microscopy and flow cytometry.

It is therefore a primary object of the present invention to provide stabilization of the excitation mechanism in fluorescent identification and measurement systems.

It is another object of the present invention to create a solid-state light source that will eliminate the inherent variations that other light sources such as plasma-based and mercury vapor introduce into a system.

It is another object of the present invention to create a more efficient, accurate and stable narrow band light source instead of using broad spectrum lamps and filtering more than 99% of the output energy to create the narrow band light source desired.

It is another object of the present invention to implement a diode-based light source with an active feedback control for a reduction in irradiance variation that will significantly reduce irradiance variation.

It is another object of the present invention to significantly decrease the statistical spread of measured emissions using this excitation system in fluorescent measurements.

It is another object of the present invention to create an embodiment of the invention for use in fluorescent microscopy systems.

It is another object of the present invention to create an embodiment of the invention for use in flow cytometry systems.

It is another object of the present invention to create a stable light source to excite and measure the level of fluorescence from fluorescent markers used in biological experiments and assays.

It is an objective of the current invention that the excitation mechanism provide a repeatable, proportional value for the detected fluorescence signal using a narrow band output from a solid state excitation source in the place of a wide spectrum vapor lamp.

It is another object of the present invention to increase accuracy, sensitivity and specificity measurements using fluorescence markers and tools.

It is another object of the present invention to increase the reproducibility and reliability of measurements by reducing variability, and increasing stability, in light source.

It is another object of the present invention to increase ability to calibrate light-based systems due to the enhanced stability of the light source.

It is another object of the present invention to reduce photo-bleaching caused by superfluous exposure to light frequency excitation of fluorophore molecules.

It is another object of the present invention to create efficiencies and cost savings given that the average lifetime of the light source will significantly increase and replacement costs will be significantly reduced.

These and other objects of the present invention, will become apparent to those skilled in this art upon reading the accompanying description, drawings, and claims set forth herein.

### BRIEF DESCRIPTION OF THE DRAWINGS

FIG. 1 is a systems diagram detailing the various sub systems of the present invention.

FIG. 2 is a systems diagram of the epiflourescence microscopy embodiment of the invention.

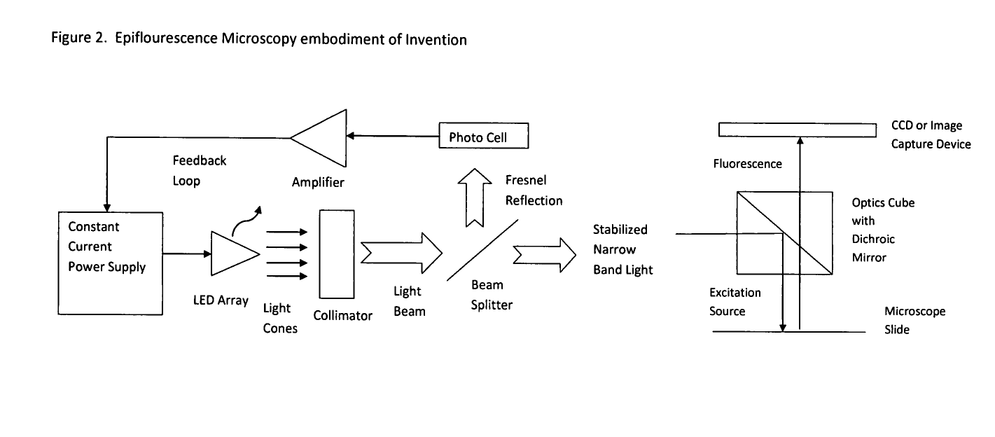

FIG. 3 is a systems diagram of the flow cytometry embodiment of the invention.

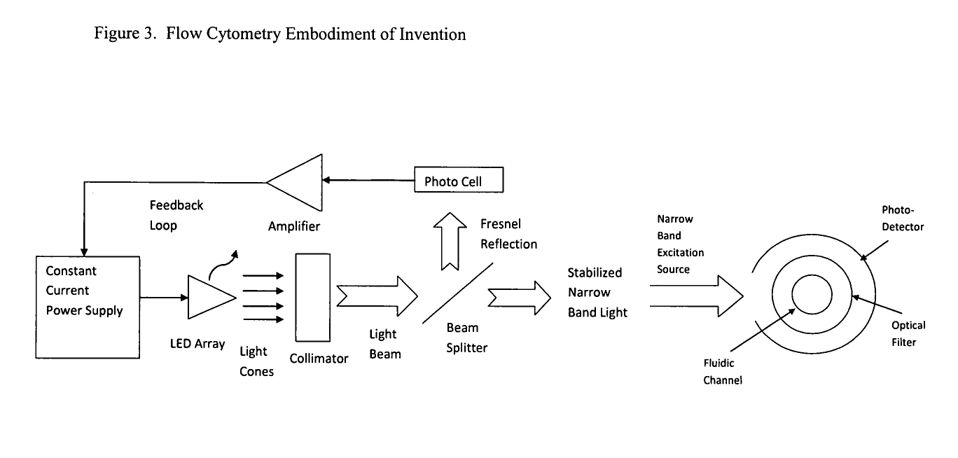

### DETAILED DESCRIPTION OF THE INVENTION

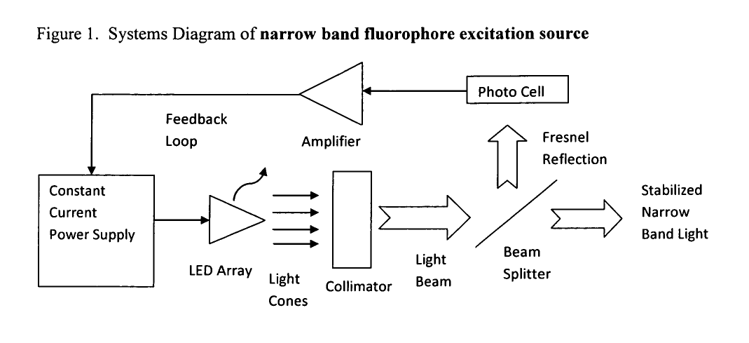

FIG. 1 shows a systems diagram of the best mode for carrying out the invention contemplated by the inventors of the solid state constant feedback light emitting diode (LED) narrow band fluorophore exciter. It is a solid-state light source based on a light emitting diode (LED) array of unique geometry driven by a constant current power source with active feedback control. This system can be implemented for broad frequency ranges or for narrow band frequencies depending on the characteristics of the LEDs chosen to populate the array and the geometry of the array. The invention can be used as an excitation light source for fluorescent microscopy and flow cytometry applications as an efficient and stable alternative to existing light sources such as broadband mercury vapor bulbs and plasma-based light sources. Benefits of the current invention include: durability; stability; reduced operating expenses; reduced variance of output; and increased accuracy of frequency and amplitude. This system will provide benefits as the excitation mechanism in fluorescent identification and measurement systems such as microscopy and flow cytometry using biomarkers, fluorophores, and other fluorescent agents ad antigens.

### LED Characteristics

Light emitting diodes have developed rapidly in the past 20 years and now many different kinds are manufactured with various frequency and bandwidth characteristics. With simple collimating optics, a closely spaced array on a printed circuit board can produce a homogenous beam that can then be sampled for the feedback. The output characteristics of the LED array if not driven near the limits can provide an extremely stable output for consistent excitation of fluorophores.

### Array Geometry

The array geometry can be designed and tailored to create the desired light field at the focal plane. The overlapping output cones to be collimated for a homogenous illumination field.

### Power Supply

A constant current power supply of high stability is incorporated in the invention to provide an accurate and stabile source to the LEDs. Using feedback directly sampled from the beam, the collimated light source can be controlled to compensate for any spurious variations and can be controlled for degradation of the LED outputs over the life of the LEDs.

### Feedback Loop

A feedback loop is designed and incorporated in the invention in order to make instantaneous adjustments to the system to maintain constant light output and minimize variations. The feed back loop consists of monitoring a Fresnel reflection taken from the collimated beam for real time control of the output.

### Benefits

The invention can increase the accuracy, sensitivity and specificity of fluorescent measurements by stabilizing the light source used to make readings and measurements. Refining the use of fluorescent microscopy and flow cytometry using a light source tailored to the characteristics of fluorophore molecules and fluorescent markers can improve measurement consistency and increase the ability to identify elements of interest. That in turn will increase specificity by differentiating between elements of interest and noise.

This system will reduce areas of variability involving the excitation mechanism for the fluorescence emission of fluorophore molecules and fluorescent markers such as molecules having several highly efficient absorption bands for excitation including the Soret and Q bands. It will also reduce photobleaching of the fluorophore due to exposure and excitation by undesired light frequencies.

The invention will reduce the need to use a very narrow, low absorption region of the mercury vapor lamp to limit the amount of excitation in order to reduce photobleaching. In the case where this band of wavelengths falls in a relatively low emission area of the output spectrum of the mercury vapor lamp, stability can be a significant issue. This condition can result in a significant variation of the irradiance at the microscope slide due to the instabilities inherent in a plasma light source. The mercury vapor lamps also have a limited lifetime of approximately 250 hours. Therefore a more stable light source can result in lower cost of operation.

The very design of an epifluorescent microscope was done for capturing images using a variety of fluorophores to highlight specific structures of biological samples. By using stains with affinities for specific molecular receptors, the researcher or operator can increase the contrast of the desired structures relative to the surrounding elements of a cell or biological sample. The stains and their reading by fluorescent microscopy thereby highlight the aspects that the researcher is studying or the operator is interested in. However, studies using epifluorescent microscopy were not designed to measure the photonic emission of specific receptors and therefore all excitation sources were designed to be very broad spectrum emitters. This is why the present invention does not flow from the prior art or can be taught from the prior art.

There are similar limitations on the light sources used in flow cytometry systems.

Existing microscope imaging systems were designed to increase the contrast of the different cellular structures. This is done by having fluorophores, with differing emission wavelengths, attach to different structures. Thereafter, by filtering the emitted light into different spectral bands, researchers could isolate the cellular structures from one another. By imaging the structures at different wavelengths, researchers could essentially subtract the unwanted structures from the images using simple optical filtration. This approach is not optimal in all cases and the current invention addresses these limitations.

The solid state diode light source detailed in this invention will accomplish several objectives: First, it will stabilize the excitation source as compared with the plasma-based light source that varies in physical location inside the bulb from bulb to bulb. In the past, a 5% location variation was acceptable if using a fluorophore as a contrasting agent. New assay ideas require something different and can require measurement of the relative emission of whole cells and the specific characteristic of cells, for example. In order to accomplish this objective, the technology used to read the sample must limit the variations in irradiance both spatially over the surface area of the measurement region and also in time, so that a given exposure over time provides a comparable value, measurement after measurement for reproducibility and reliability. When a mercury vapor lamp is utilized, a significant number of man-hours are required to realign the microscope every time the light source is changed. The invention not only will provides a stable excitation source that will further automate and objectify the reading of samples, but it also will significantly lower costs of the assays overall.

Cells tagged with fluorescent markers can be identified by specific spectral signatures of the fluorescing photons and these light signatures from excited fluorophores can be more accurately measured with the invention's solid state LED excitation source.

What is claimed is:

1. A System for creating a light emitting diode-based light source with an active feedback control to control irradiance and make for a reduction in irradiance variation that will significantly reduce irradiance variation.

2. A system according to claim 1 to create a narrow band light source that can be used to excite fluorophores at specific frequencies.

3. A system according to claim 1 to create a system for a bandwidth tailored solid state light source of high stability.

4. A system according to claim 1 to create a more efficient, accurate and stable narrow band light source by using an LED array instead of using broad spectrum lamps and filtering more than 99% of the output energy to create the narrow band light source desired.

5. A system according to claim 1 to create a stable light source to excite, at their specific excitation frequencies, and measure the level of fluorescence from fluorescent markers used in biological experiments and assays.

6. A system according to claim 1 utilizing a closely spaced LED array on a printed circuit board and collimating optics to can produce a homogenous light beam that can then be sampled for the feedback.

7. A system according to claim 1 to create a stable light source by introducing a feedback loop where by the collimated light beam from the LED array is split with a beam splitter and the reflection light hits a photo cell whose output is amplified and fed back to the power supply powering the LED array.

8. A system according to claim 1 to reduce photo-bleaching caused by superfluous exposure to light frequency excitation of fluorophore molecules.

9. A system according to claim 1 to create a solid-state light source that will eliminate the inherent variations that other light sources such as plasma-based and mercury vapor introduce into a system.

10. A method for stable narrow band light source to excite and measure the level of fluorescence from fluorescent markers used in biological experiments and assays.

11. A method according to claim 10 to significantly decrease the statistical spread of measured emissions using this excitation system in fluorescent measurements.

12. A method according to claim 10 to create a more efficient, accurate and stable narrow band light source instead of using broad spectrum lamps and filtering more than 99% of the output energy to create the narrow band light source desired.

13. A method according to claim 10 to create a stable light source to excite and measure the level of fluorescence from fluorescent markers used in biological experiments and assays.

14. A method according to claim 10 to reduce photo-bleaching caused by superfluous exposure to light frequency excitation of fluorophore molecules.

15. A method according to claim 10 to process the overlapping LED output cones to be collimated for a homogenous illumination field.

16. A method according to claim 10 to increase accuracy, sensitivity and specificity measurements using fluorescence markers and tools.

17. A method according to claim 10 to increase the reproducibility and reliability of measurements by reducing variability, and increasing stability, in light source.

18. A method according to claim 10 to increase ability to calibrate light-based systems due to the enhanced stability of the light source.

19. System and methods comprising an embodiment of the invention as a narrow band fluorophore excitation source for use in epiflourescence microscopy.

20. System and methods comprising an embodiment of the invention as a narrow band fluorophore excitation source for use in flow cytometry.
